(19) United States
(12) Patent Application Publication
(10) Pub. No.: US 2022/0335539 A1
(43) Pub. Date: Oct. 20, 2022

(54) SYSTEM FOR LOCATION-BASED SOCIAL NETWORKING

(71) Applicants: Justun Aramus Lynch, Atlanta, GA (US); Christopher Jackson Whiddon, Taylorsville, NC (US)

(72) Inventors: Justun Aramus Lynch, Atlanta, GA (US); Christopher Jackson Whiddon, Taylorsville, NC (US)

(21) Appl. No.: 17/710,437

(22) Filed: Mar. 31, 2022

Related U.S. Application Data
(60) Provisional application No. 63/168,725, filed on Mar. 31, 2021.
(60) Provisional application No. 63/226,336, filed on Jul. 28, 2021.

(51) Int. Cl. G06Q 50/00; G06F 16/9537; H04L 51/52

(52) U.S. Cl. CPC G06Q 50/01; G06F 16/9537; H04L 51/52

(57) ABSTRACT

A system for location-based social networking is disclosed. The system includes at least one computing device in operable communication with a network. An application server is in operable communication with the user network and configured to host an application system for permitting users to communicate with one another based on their geographic proximity to one another via a communications module in operable communication with an application interface. A GPS module determines the location of each user and the proximity therebetween. A mapping module receives each user's location from the GPS module and displays their location on a map. A permissions module is in operable communication with a payment processing module. The permissions module to permit a user to input a payment amount to be rendered prior to communications between users to be permitted.

### CROSS-REFERENCE TO RELATED APPLICATIONS

The present application claims priority to U.S. Provisional Patent Application No. 63/168,725 filed Mar. 31, 2021, entitled “SYSTEM FOR LOCATION-BASED SOCIAL NETWORKING,” and to U.S. Provisional Patent Application No. 63/226,336 filed Jul. 28, 2021, entitled “SYSTEM FOR LOCATION-BASED SOCIAL NETWORKING,” which are hereby incorporated by reference in their entirety.

### TECHNICAL FIELD

The embodiments generally relate to social networking systems and methods and more particularly to social networking systems and methods with geographic proximity-based features.

### BACKGROUND

Social networking platforms are a useful and popular means for staying in contact with friends, family, and colleagues as well as for making new connections. These applications run on mobile devices, such as smartphones, as mobile applications or on software designed to run on desktop computers.

Current social networking systems often do not account for geographic proximity-based social networking. Those which do account for the location of the users often require the user to manually input their location information, while some will only track the user's location while they are using the application. Some applications may actively track the user's location, but they do not account for the users interests or personal preferences when suggesting connections therebetween. Further, many users of social networking platforms are inundated by high volumes of incoming communications. This is attributed to the ability of any user to connect with any other user.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein disclose a system for location-based social networking. The system includes at least one computing device in operable communication with a network. An application server is in operable communication with the user network and configured to host an application system for permitting users to communicate with one another based on their geographic proximity to one another via a communications module in operable communication with an application interface. A GPS module determines the location of each user and the proximity therebetween. A mapping module receives each user's location from the GPS module and displays their location on a map. A permissions module is in operable communication with a payment processing module. The permissions module to permit a user to input a payment amount to be rendered prior to communications between users to be permitted.

The embodiments allow for users to establish a payment amount which must be rendered before accessing a communications interface associated with the user. This provides an advantage in view of prior systems by reducing incoming communications by requiring the payment of a fee. In such, users associated with the incoming communications are pre-vetted, increasing the quality and efficiency of communications within the platform.

In one aspect, the system includes a GPS module to facilitate the determination of each user.

In one aspect, the GPS module determines the proximity between each user.

In one aspect, a mapping module is in operable communication with a user interface module, the mapping module.

In one aspect, the system includes a user database to store user information.

In one aspect, the user information is comprised of at least one user interest.

In one aspect, each user is matched based on each user's proximity and each user's interest.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system infrastructure and application program in communication with the computing system, according to some embodiments;

FIG. 2 illustrates a block diagram of the application system, according to some embodiments;

FIG. 3 illustrates a block diagram of the server engine and modules associated with the location-based social networking system, according to some embodiments; and

FIG. 4 illustrates a flowchart of a method for matching users and permitting communications based on location and interests, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provided herein relate to a location-based social networking system which allows for users to connect with one another based on their current geographic location as well as their interest. Users may create a profile which includes images, personal information, and areas of interest. If a user wishes to connect directly with another user, the user may send the other user a message, notification, or other means of communication.

As used herein, the term “communication” may be used to describe various forms of communications between at least two users which are executed using a computing device (e.g., a smartphone). The communication may be a text message, email, telephone call, social media message, etc.).

In some embodiments, users may require a payment to be submitted by a user who wishes to communicate with them. Alternatively, no payment may be required if desired by the user. A dialogue may not commence until the recipient responds to the introductory message. In such, the initial sender of the communication is prevented from repeatedly messaging an unresponsive recipient.

In some embodiments, a mapping feature will show all users on a map, such as by showing users as colored dots, icons, or the like. This will allow a user to know where other clusters of users are present in real-time to facilitate connections therebetween.

In some embodiments, a user will not be able to see other users' profiles unless they are within a pre-defined proximity of the other user (e.g., within 100-feet). The system may provide directions to the matched user via a mapping feature.

In some embodiments, the system includes a shared content feed of pictures and videos that users post which can be viewed by other users. The information provided on the content feed may be automatically delete within a given amount of time depending on local activity, user preferences, etc. Intertwined with this feed, the system will be running paid ads of businesses located within the same proximity.

In some embodiments, the system may include a paid, local event listing. Event promoters may be able to list their events and users will be able to find them based on a selected geographical radius. In this example, the listings may be available for 12-hours prior to the event starting and the listing may be deleted at the conclusion of the event. In some embodiments, the system may incorporate news articles or other publications.

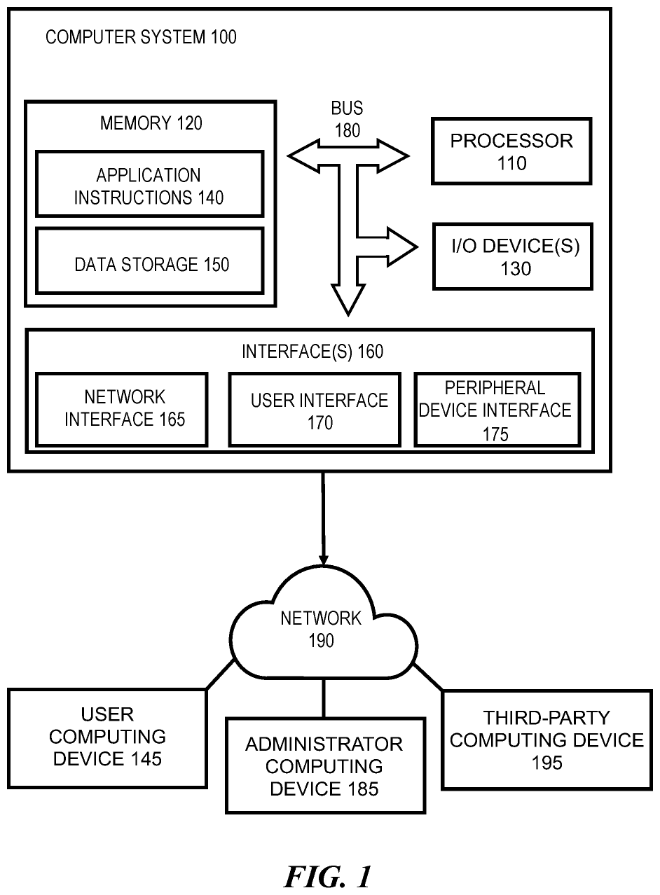

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application-Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185, and a third-party computing device 195 each in communication via the network 190. The administrator computing device 185 is utilized by an administrative user to moderate content and to perform other administrative functions.

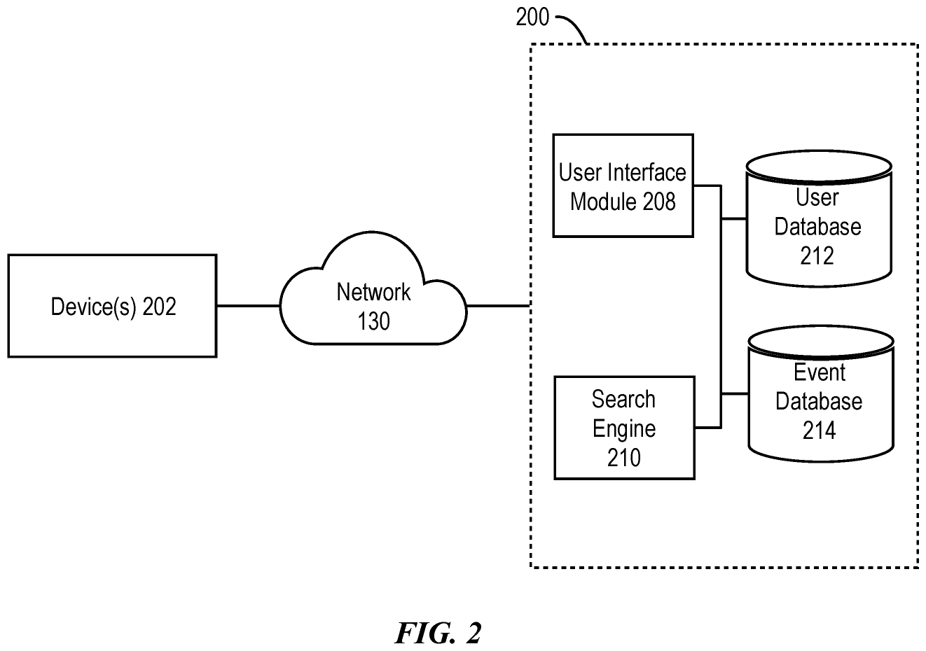

FIG. 2 illustrates a block diagram of the application system 200 in operable communication with a user device 202 via a network 130. The device 202 is utilized by the user to interact with features provided by the system described herein, including to communicate with other users, locate users via the GPS module and mapping feature, determine the interests of other users, etc. The application system 200 includes a user interface module 208 to display user information, permit interactions between users via the user interface, locate users, etc. A search engine 210 permits the user to search a user database 212 which may include information related to themselves or other users. User information may include user images and/or videos, user contact information, user locations, interactions histories, and the like. The events database 214 stores event information including event duration, details of the event, users attending the event, event advertisements, etc.

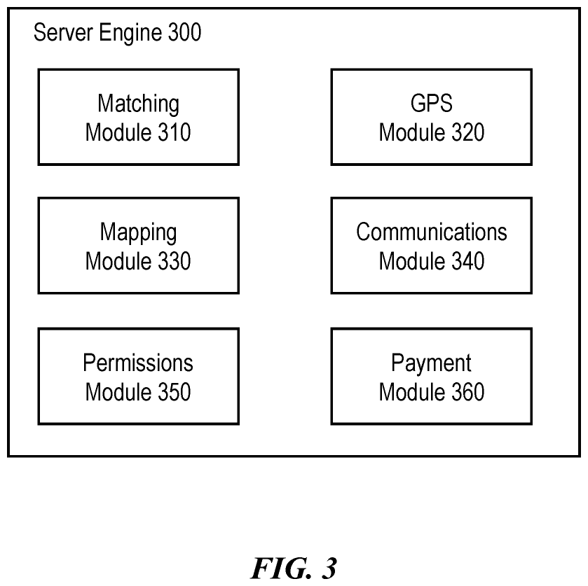

FIG. 3 illustrates a block diagram of the server engine 300 and modules including a matching module 310, GPS module 320, mapping module 330, and communications module 340. The matching module 310 permits and initiates the connection between a first user and a second user (or groups thereof). Users may be matched based on the proximity between one another (such as within a 100-foot proximity). Locations of each user and their proximity is determined by the GPS module 320 which signals the communications module 340 that the users within the pre-defined proximity may communicate with one another. Each user within a pre-defined proximity will be displayed on a map via the mapping module 330. The mapping module receives specific location from the GPS module 320 and displays the location of each user via an indicator (e.g., a color-coded dot, icon, etc.). The communications module 340 permits communications between each user, event administrator, advertisement providers, etc. The communications module 340 may restrict communications if a user has not yet responded to an initial inquiry. Communications may be permitted when users are outside of the pre-defined proximity if a connection between the two users has already been established.

In some embodiments, the communications module 340 may permit users to interact with one another via e-mail, applications messaging systems, social media messaging systems, telephone, or other means of communication between computing devices.

In some embodiments, the matching module 310 receives interests from each user within the pre-defined proximity and separates users into groups based on their interests. The matching module 310 may then only permit the connection of compatible users, or select suitable connections based on each users interests and user preferences.

In some embodiments, users may select a rate at which other users pay to initiate communications. For example, if a first user requires a payment of $100 for another user to be permitted to communicate with them, once the payment is rendered by the second user, the second user may send a communication. This process may be performed via the permissions module 350 which receives user preferences (e.g., their required payment amount).

In some embodiments, users may charge for each communication sent and/or received or may charge a one-time payment for a pre-determined number of communications.

In some embodiments, the server engine 300 includes a permissions module 350 and a payment module 360. The permissions module 350 allows the user to select communication requirements for other users. This allows the system to determine if the users are permitted to communicate with one another. The payment module 360 may allow for payments to be transmitted between users. The payment module 360 may be in communication with the permissions module 350 to provide an indication of when payment has been rendered. Once the payment is rendered, the communication module 340 permits active communication between the users. In some embodiments, the user may define a limit of communications to be received (e.g., a single email, one phone call, etc.). One skilled in the arts will readily understand that this limit of communications may be defined by the user and readily changed.

In some embodiments, the system may include a financial services feature. This feature will essentially be a list of products (e.g., credit cards, insurance, loans, etc.) that can be useful to entrepreneurs. The system may be in communication with various API's connected to banks, insurance companies, and other financial institutions that allow their underwriters to collect information through the platform.

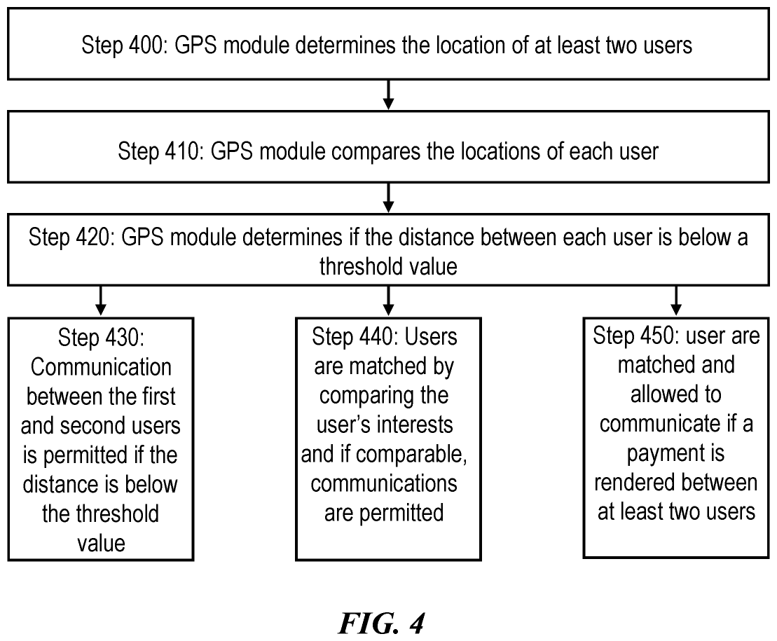

FIG. 4 illustrates a flowchart of a method for permitting a first user to communicate with a second user based on geographic location, interests, and user permissions. In step 400, a GPS module determines the location of a first user and the location of a second user. In step 410, the GPS module compares the location of the first user and the location of the second user to determine if a distance therebetween is below a threshold value in step 420. In step 430, communication between the first user and the second user is permitted if the distance therebetween is below the threshold value. In one example, the threshold value may be a maximum distance between users (e.g., 100 yards, etc.). In step 440, users are matched by comparing, via the matching module, the user's interests, and matching based on similar interest groups. For example, if both users are interested in real-estate, they may be permitted to match and communicate with one another. In step 450, users are matched and allowed to communicate if at least one user renders a payment to another user. For example, a first user may require a $10 fee in order for a communication to be sent to them. The second user may select to pay the $10 fee and be permitted to send one or more communications to the first user.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for location-based social networking, the system comprising:
at least one computing device in operable communication with a network; and
an application server in operable communication with the user network, the application server configured to host an application system for permitting users to communicate with one another based on their geographic proximity to one another, wherein users communicate with one another via a communications module in operable communication with an application interface;
a permissions module in operable communication with a payment processing module, the permissions module to permit a user to input a payment amount to be rendered prior to communications between users to be permitted.

2. The system of claim 1, further comprising a GPS module to facilitate the determination of a location of each user.

3. The system of claim 2, wherein the GPS module determines the proximity between each user.

4. The system of claim 3, further comprising a mapping module in operable communication with a user interface module.

5. The system of claim 4, further comprising a user database to store user information.

6. The system of claim 5, wherein the user information is comprised of at least one user interest.

7. The system of claim 6, wherein each user is matched based on each user's proximity and each user's interest.

8. A system for location-based social networking, the system comprising:
at least one computing device in operable communication with a network; and
an application server in operable communication with the user network, the application server configured to host an application system for permitting a first user and a second user to communicate with one another based on their geographic proximity to one another, wherein the first user and the second user communicate with one another via a communications module in operable communication with an application interface;
a GPS module to determine the geographic proximity between the first user and the second user, the GPS module in operable communication with a permissions module to permit the first user to communicate with the second user.

9. The system of claim 8, wherein the GPS module determines the proximity between each user.

10. The system of claim 9, further comprising a mapping module in operable communication with a user interface module.

11. The system of claim 10, further comprising a user database to store user information.

12. The system of claim 11, wherein the user information is comprised of at least one user interest.

13. The system of claim 12, wherein each user is matched based on each user's proximity and each user's interest.

14. The system of claim 13, further comprising an events database to store event information.

15. The system of claim 14, wherein the matching module permits users at an event to communicate.

16. A method for permitting a first user to communicate with a second user based on geographic location and user permissions, the method comprising the steps of:
determining, via a GPS module, the location of a first user and the location of a second user;
comparing, via the GPS module, the location of the first user and the location of the second user to determine if a distance therebetween is below a threshold value;
permitting the communication between the first user and the second user if the distance therebetween is below the threshold value.

17. The method of claim 16, further comprising a matching module to match the first user to the second user based on user interests.

18. The method of claim 17, wherein once the matching module matches the first user to the second user, the matching module permits communications between the first user and the second user.

19. The method of claim 18, further comprising the step of the first user receiving a payment from the second user, wherein the receipt of the payment permits at least one communication to be transmitted from the second user to the first user.
